(19) United States
(12) Patent Application Publication
(10) Pub. No.: US 2016/0306195 A1
(43) Pub. Date: Oct. 20, 2016

(54) POLYCARBONATE LENS FOR EYEWEAR AND METHOD FOR MANUFACTURING THE SAME

(71) Applicant: MIYOSHI INDUSTRIAL ENTERPRISE INC., Sabae-shi (JP)

(72) Inventor: Kazuyuki MIYOSHI, Sabae-shi (JP)

(21) Appl. No.: 14/957,542

(22) Filed: Dec. 2, 2015

(30) Foreign Application Priority Data
Apr. 16, 2015 (JP) 2015-084252

(51) Int. Cl. G02C 7/12; G02C 7/10; B29D 11/00; G02B 1/14

(52) U.S. Cl. CPC G02C 7/12; G02B 1/14; G02C 7/105; B29D 11/00644; B29D 11/00432; B29D 11/00923; G02C 2202/16; B29K 2069/00

(57) ABSTRACT

The invention relates to a polarized polycarbonate lens for eyewear including protective layers having polarizing function on both sides of a polarized layers, a polarized material with an acrylic coat layer on the convex surface of protective layer so as to be formed into lens shape, a molded part formed integrally on the concave surface of the polarized material, and a hard coat layer on the surface of the acrylic coat layer on the convex surface. The lens has features of less interference pattern and less crack generation during bending step into lens shape and forming step. Moreover, the hard coat layer may be two-layer including a primer layer to generate less interference pattern and cracks. Additionally, this lens does not generate interference pattern even when it includes tinted gradation and a hard coat layer, and the lens does not need mirror coating on the surface.

### BACKGROUND OF THE INVENTION

1. Field of the Invention

The present invention relates to a polycarbonate lens for eyewear including polycarbonate protective layers on the both sides of a polarized layer with polarizing function, an acrylic coat layer on a polarized material, and a polycarbonate molded part formed integrally on the polarized material. Also relates to a method for manufacturing of the polycarbonate lens for eyewear by means of disposing tinted layer thereon.

2. Description of the Background Art

Polarized polycarbonate lenses which include multi-layer sheet of polycarbonate formed on rear side by injection molding is excelled in shock resistance, sunglass function and polarizing function, and is preferably used in outdoor sports, especially in marine sports, in order to avoid glare of water surface reflection. Moreover, products with improved design, which have gradation by tinting on the polycarbonate lens, are provided.

A conventional method for gradation processing of the polarized polycarbonate lens is including, disposing dyeable coat on a molded lens and tinting the dyeable coat.

This conventional method is vulnerable when using, since dyeable coating is softer than hard coating which is usually used, or this conventional method is difficult to control density, since the other side is deleted by grinding when using semi lens, for example, color of the other side of lens would pass away when dyeable coating and tinting is performed at semi stage. Therefore, it is necessary to dye one by one, or to perform dyeable coating and tinting after the other side of the semi lens is deleted by grinding.

To address those problems, a method was proposed. The method includes following steps: preparing material with removable protective layer on the protective layer on the both sides of polarized film with polarizing function, heating the material to the grass transition temperature of polycarbonate, bending the material into approximate convex curve, removing inner protective layer remaining surface protective layer, and tinting polycarbonate layer (refer to U.S. Pat. No. 8,651,660).

However, this method in prior art has a problem that protective layer on the convex surface is easily stripped in part by elongation stress during bending process. Additionally, since it is difficult to contain adhesive in removable protective layer because of weak chemical resistance of polycarbonate, perimeter of protective layer is easily stripped in part due to weak adhesive power. Then, once protective layer is stripped, color heterogeneity is generated by penetrating dyeing liquid into the stripped area.

Meanwhile, generally, polycarbonate has generally low-hardness, and hard coat layer is disposed on the polycarbonate layer to avoid scratch when it used for eyewear use. However, because thickness of common hard coat layer is thin, only 1-2 μm, it is difficult to obtain high-hardness by simply adding the hard coat on a surface of low-hardness polycarbonate. Therefore, it has a problem of arising a crack on convex surface when bending polycarbonate material disposed with hard coating layer to a form of lens which provides a specific curvature.

Moreover, since visible light of polycarbonate has high refractive index of 1.585, the difference of refractive index tends to cause interference pattern when hard coat of 1-2 μm is added. So, many kinds of eyewear with polarizing function used in outdoor, such as sports, apply mirror coat on the surface of the lens in order to hide the interference pattern.

However, as the polarized lens tinted gradation has fashionability more than sporting use, mirror coating on the surface reduces the additional value by hiding gradation. Therefore, lens with interference pattern on hard coat layer is less preferred than common polarized lens, and thus, it needs to be improved.

### SUMMARY OF THE INVENTION

A first object of the present invention is to provide a polycarbonate lens for eyewear including a polarized material having protective layers on both surfaces of polarized film, and integrally formed polycarbonate by injection molding. Although a hard coat layer is provided on a surface thereof, the lens generates less interference pattern and does not generate cracks during bending process into lens shape and injection molding. Furthermore, a second object is to provide a polycarbonate lens for eyewear including tinted gradation and a hard coat without interference pattern, which does not need mirror coating on the surface.

To solve the above problems, this polarized polycarbonate lens for eyewear adopts a polarized layer having polarizing function, polycarbonate protective layers on both sides of the polarized layer, an acrylic coat layer on one side surface of the polycarbonate protective layers, a polarizing material formed into lens shape such that the surface side provided with the acrylic coat layer becomes the convex surface side, a polycarbonate molded part formed integrally on the concave surface side of the polarizing material and a hard coat layer over whole surface of the lens including the surface of the acrylic coat layer on the convex surface.

The hard coat layer is preferably two-layer including a primer layer and a hard coat layer. The polarized material is preferably disposed tinted layer by tinting on one or both side of the convex surface of the acrylic coat layer and the concave surface of the polycarbonate protecting layer.

Also, another aspect of the present invention is a method of manufacturing the polycarbonate lens for eyewear, including the step of, disposing polycarbonate protective sheet on both sides of polarized layer having polarizing function, preparing a polarizing material sheet comprising an acrylic coat layer on one side of the polycarbonate protective layers, processing a polarizing material sheet formed into lens shape and processing into a polarized material with a specific curvature such that the surface on the acrylic coat layer becomes the convex surface, forming integrally a polycarbonate molded part on the polarizing material on the concave surface, and disposing a hard coat layer over whole surface of the lens including the acrylic coat layer on the convex surface. Coloring can be performed by an intervention of coloring step, between the polarizing material processing step and the casting step, which is to color on the surface of the polarizing material by soaking the polarizing material into dyeing liquid. In addition, on coloring step, the tinted layer can be gradation-processed.

According to another aspect of the present invention, the polycarbonate lens for eyewear may include the acrylic coat layer on the convex surface of the polycarbonate protective layer constituting polarizing material, and the hard coat layer is provided on the acrylic coat layer in order to reduce interference pattern on the lens surface by effect of the multilayer and prevent crack generation during bending into lens shape and injection molding of polycarbonate. Also, the hard coat layer preferably includes a primer layer and a hard coat layer in order to reduce interference pattern of the lens.

Moreover, according to another aspect of the present invention, the polycarbonate lens for eyewear may further include tinted gradation on the polarized material and the hard coat layer to provide the lens with no interference pattern, and thus, the polycarbonate lens for eyewear does not need mirror coating.

### BRIEF DESCRIPTION OF THE DRAWINGS

FIG. 1 shows cross-section view of a polycarbonate lens for eyewear according to first embodiment of the present invention.

FIG. 2 shows cross-section view of a polycarbonate lens for eyewear according to second embodiment of the present invention,

FIG. 3 shows cross-section view of a polycarbonate lens for eyewear according to third embodiment of the present invention,

FIG. 4 shows flowchart of manufacturing method according to first embodiment of the present invention,

FIG. 5 shows cross-section view of lenses on each manufacturing step,

FIG. 6 shows flowchart of manufacturing method according to second embodiment of the present invention,

FIG. 7 shows cross-section view of lenses on each manufacturing step.

### DESCRIPTION OF THE PREFERRED EMBODIMENTS

Hereinafter, embodiment of the present invention will be described in detail with reference to drawings.

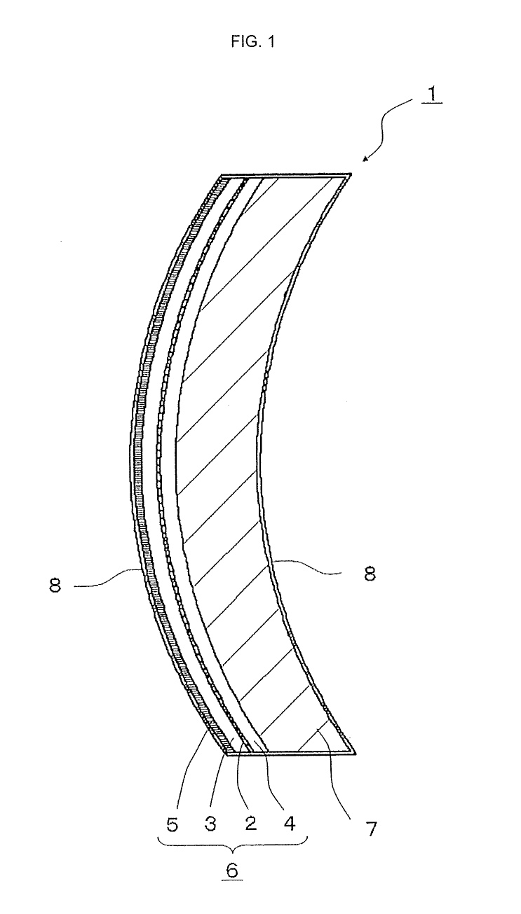

The first embodiment of the present invention will be described with reference to FIG. 1.

Referring to FIG. 1, the polarized polycarbonate lens for eyewear 1 configured of polarized layer 2 includes polycarbonate protective layers 3, 4 on the polarized layer 2, an acrylic coat layer 5 is formed on the convex surface of the polycarbonate protective layer 3 to form a polarized material 6 protected by the acrylic coat layer 5. Also the polarized material has lens shape with integrally bonding polycarbonate molded part 7, which has an identical chemical structure with polycarbonate protective layer 4, by injection molding on concave surface of polarizing material 6, that is to say the polycarbonate protective layer 4. Also, the polycarbonate lens is configured further to include a hard coat layer 8 over the whole surface of the lens from the convex surface of acrylic coat layer to concave surface of the polycarbonate molded part 7.

The reason why acrylic coat layer 5 is disposed only on the surface of polycarbonate protective layer 3 on the convex side of polycarbonate protective layer 3 and 4 is as explained below. The first reason is because during bending polarizing material 6 into lens form before integrally bonding polycarbonate molded part 7 by injection molding, high strength acrylic coat layer 5 prevents convex surface on which load is applied in a compression direction from arising crack. The second reason is because polycarbonate layer 4 which has an identical structure should be retained, in order to solve the problem that the layer cannot be fused due to a formation of interface when acrylic coat layer which differs in structure is disposed in the border of casting, during integrally bonding the main lens part of polycarbonate molded part 7 into concave surface of polarizing material 6. The third reason is because a little scar of concave surface of polycarbonate layer 4 of polarizing material 6 would be indistinctive and arising of interference pattern can be prevented, since same polycarbonate layer has a same index of refraction.

The first embodiment of present invention, as described above, is the polycarbonate lens for eyewear 1 including the acrylic coat layer 5 on the polycarbonate protective layer 3 on the convex surface of the polarized material 6, and the hard coat layer 8. The lens can reduce interference pattern on the lens surface by the effect of multi-layer, maintaining hardness to protect polycarbonate protective layer 3 by sheeting acrylic coat layer 5, and preventing crack generation on convex surface during bending into lens shape.

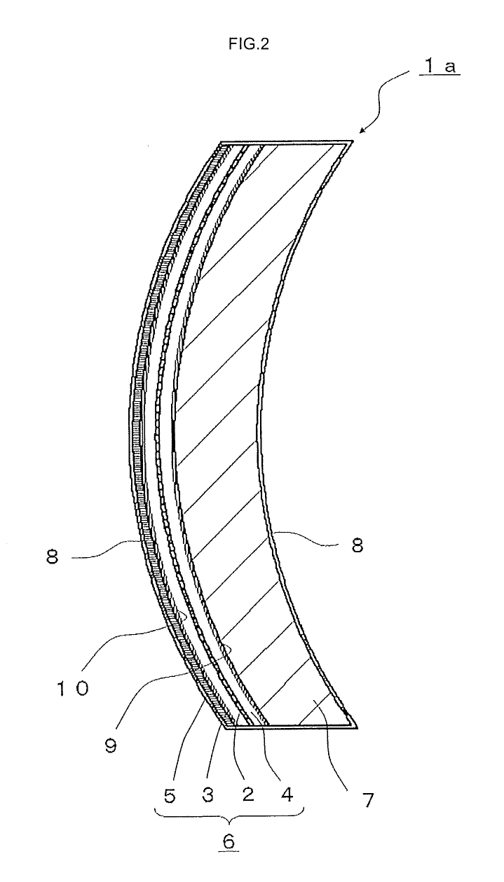

The second embodiment of present invention will be described with reference to FIG. 2. This embodiment is further including tinted layer on the both sides of the polarized material 6 in the first embodiment. Specifically, the polycarbonate lens for eyewear 1a is including tinted layers 9, 10 on the convex and concave surfaces of the polarized material 6. The tinted layer is formed on the both sides of the polarized material 6 before forming integrally of polycarbonate molded part 7 to the polarized material 6 by injection molding. Here, tinted layer 10 on convex surface, as shown in figures, is disposed on the convex surface of the polycarbonate protective layer 3 penetrating and tinting the acrylic coat layer 5 when the surface of acrylic coat layer 5 included in the polarized material 6 is tinted. The tinted layer 10 is relatively weak concentration compared with tinted layer 9 which is directly tinted on the surface of the polycarbonate protective layer 4 on the concave surface, however, from the surface, it can be recognized that the convex side is also tinted.

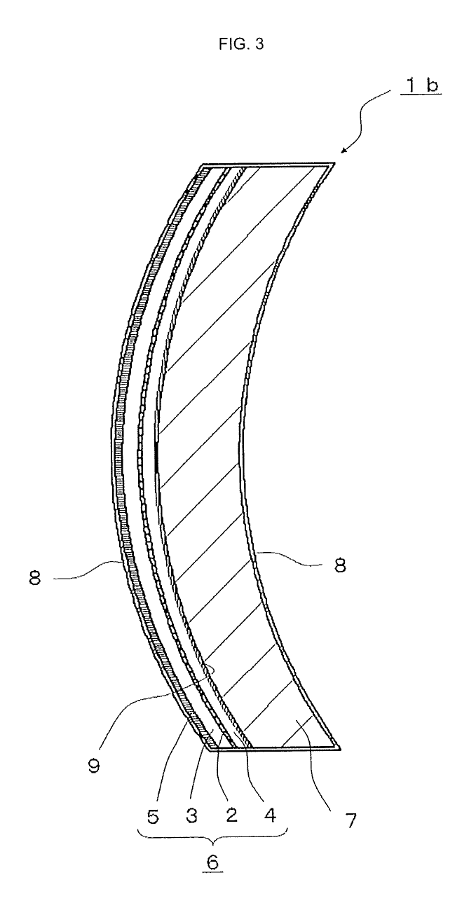

Next, the third embodiment of the present invention will be described with reference to FIG. 3. This embodiment is, compared to the first embodiment, polycarbonate eyewear 1b further including tinted layer 9 on the concave surface of the polycarbonate protective layer 4 on the concave surface of the polarized material 6. Tint condition of tinted layer 9 on concave surface can be recognized from front side of the lens through the each layer of the polarized material 6.

This embodiment, as described above about second and third embodiments, can improve design of products by means of disposing tinted layer on the polycarbonate lens for eyewear 1 in the first embodiment as described above. The tinted layer may be with uniform tint or changing tint density, such as gradation.

As described in the first to the third embodiments, the methods include disposing a primer layer and then disposing a hard coat layer 8 over the whole surface of the lens from the convex surface of acrylic coat layer 5 to the concave surface of the polycarbonate molded part 7 to obtain two-layer configuration in order to strengthen protection of the polycarbonate layer 3 with the acrylic coat layer 5 and manufacture lens which reduces interference pattern.

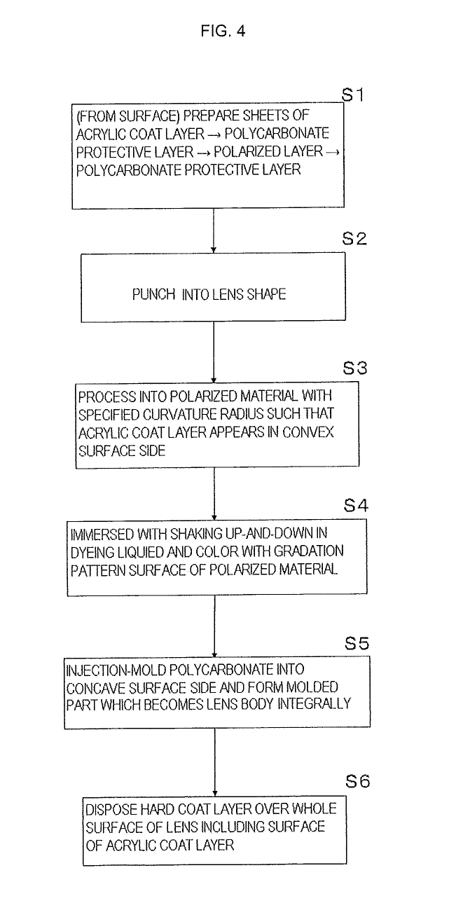

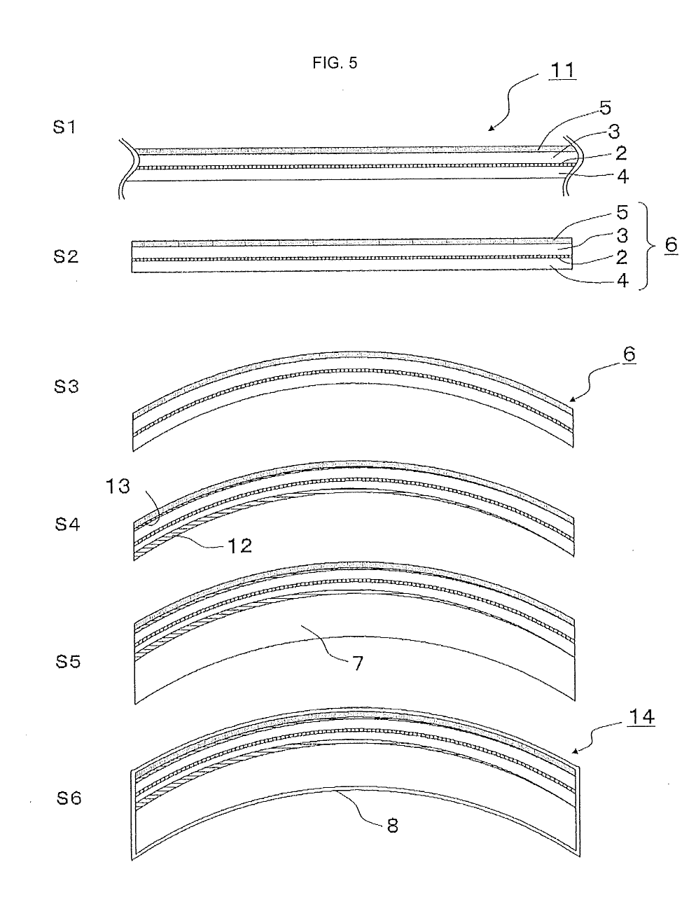

Then, the method for manufacturing of the polycarbonate lens for eyewear will be described. At first, the first method for manufacturing of polycarbonate lens for eyewear 1a including tinted layer on the both side of polarized material 6 shown in FIG. 2 will be described with reference to FIGS. 4 and 5. FIG. 4 shows flowchart of manufacturing method, and FIG. 5 shows cross-section view of lenses on each manufacturing step.

At first, in the first step S1, a sheet shaped material 11 including polarized layer 2 between polycarbonate protective layers (sheets) 3, 4 that have a specified thickness by stretch processing and acrylic coat layer 5 on the surface of the protective layer 3 is prepared as a component of above-mentioned polycarbonate lens for eyewear 1a.

In the following step S2, this sheet shape material 11 is processed into lens shape to obtain sheet shaped polarized material 6 of each polycarbonate lens for eyewear 1. In the next step S3, this processed polarized material 6 is processed into polarized material 6 with specified curvature radius with the acrylic coat layer 5 upside using a concave dish with the specified curvature radius by heat processing, such that the acrylic coat layer 5 becomes convex surface side. In this third step S3, as processed sheet shaped polarized material 6 needs to be processed into polarized material 6 with specified curvature radius, polycarbonate 3,4 is heated to the temperature in which polycarbonate is sufficiently soften in order to bend the sheet shape polarized material 6 mainly consisted of polycarbonate 3, 4, with no difficulty.

Here, since acrylic coat layer 5, which is used in sheet shaped material 11 prepared in the first step S1, has high-hardness by UV curing, it is difficult to bend the material directly. Thus, the sheet of the acrylic coat layer 5 used in an embodiment of the present invention allows bending with heating polycarbonate 3,4 in the third step S3 and specified proper valance in order to maintain hardness and stretch against bending to protect the polycarbonate 3.

The polarized material 6 bent in the third step S3 is disposed on tinted layers 12, 13 on the convex and the concave surface of polarized material 6 tinted in dyeing liquid in the following fourth step S4. The tinted layers 12, 13 are tinted by means of immersing in dyeing liquid with up-and-down to obtain gradation pattern. Also, the tinted layer 13 on the acrylic coat layer 5, as described in aforementioned second embodiment, forms layer on convex surface of polycarbonate protective layer 3 penetrating and tinting this acrylic coat layer 5 when tinting the convex acrylic coat layer 5 consisting the polarized material 6. Additionally, tinting can be chosen by design of polycarbonate lens for eyewear without sticking gradation pattern.

The figure shows colored lens immersed with shaking up-and-down in dyeing liquid with left side of lens aimed downward, and the figure shows tinted layers 12 and 13 in coloring step of the fourth step S4, with the layers are thick in left side and the layers are thin in right side. Gradation density is indicated by the thickness.

Next, in the fifth step S5, the polarized material 6 is placed in metallic mold, and then polycarbonate is injection-molded into the concave surface of the material in order to form an insert polycarbonate molded part 7 strongly bonded with the polycarbonate layer 4 of the concave surface of the polarized material 6. Then, in next sixth step S6, a hard coat layer 8 is disposed over the whole surface of the lens from the convex surface of the acrylic coat layer 5 to the concave surface of the polycarbonate molded part 7 to complete the polycarbonate lens for eyewear 14.

The present invention can manufacture the polycarbonate lens for eyewear 14 including gradation tinted layer on the both sides of the polycarbonate protective layers 3,4 which are on the both sides of the polarized layer 2 and protected with the acrylic coat layer 5 and the hard coat layer 8. This polycarbonate lens for eyewear 14 has the same basic component as aforementioned polycarbonate lens for eyewear 1a according to the second embodiment of present invention, and its property and effect are nearly identical. However, they are difference in appearance because polycarbonate lens 14 has gradation on tinted layers 12, 13, which is more specified than polycarbonate lens 1a that has simply tinted layers 9, 10. Tinted layers 12, 13 with gradation by this method for manufacturing method can be performed by changing the width of up-and-down movement when immersing in dyeing liquid with up-and-down in the fourth step S4.

The first providing method described in the above shows how to provide polycarbonate lens for eyewear 1a in second working example in FIG. 2. By skipping coloring step of the fourth step S4 of the processes of first manufacturing method, the above mentioned polycarbonate lens for eyewear 1a, described in first working example in FIG. 1, may be manufactured. Though the coloring of the fourth step S4 was the method to color gradation, the other coloring layer may be formed by selecting the other coloring method in this step.

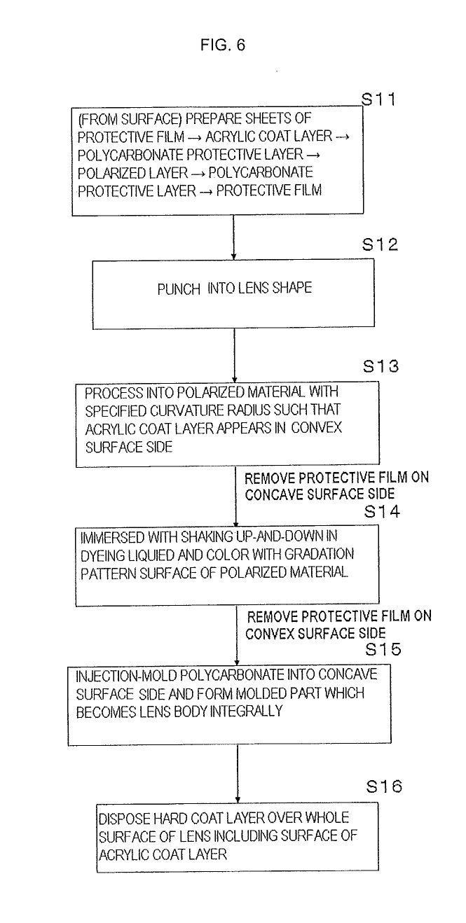

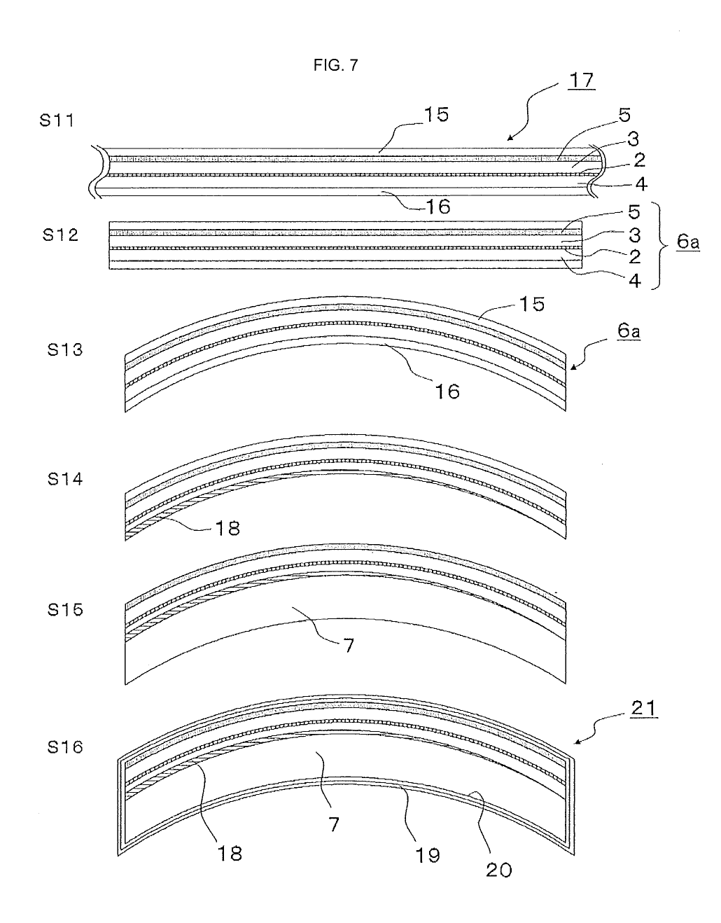

Next, a second method for manufacturing a polycarbonate lens for eyewear 1b shown in FIG. 3 including a tinted layer on the concave surface of a polarized material 6 will be described with reference to FIGS. 6 and 7. FIG. 6 shows flowchart of manufacturing step and FIG. 7 shows sectional view of the lenses in each step.

At first, in the first step S11, a base sheet of polarized material 17 including polarized layer (film) 2 between polycarbonate protective layers (sheets) 3, 4 with specified thickness and by stretch processing, an acrylic coat layer 5 on the surface of one side of polycarbonate protective layer 3, and removable protective sheets 15, 16 on the both sides of thereof is prepared as a component of aforementioned polycarbonate lens for eyewear 1b.

In next second step S12, as described in the first method for manufacturing, sheet shaped material 17 is processed into lens shape in order to obtain a sheet shaped polarized material 6a of each polycarbonate lens for eyewear 1 with protective sheets 15, 16. This processed sheet shaped polarized material 6a is processed, as described in first manufacturing method, into polarized material 6a with specified curvature by means of bending with heating on a concave dish with specified curvature in the following third step S13 such that the acrylic coat layer 5 becomes convex surface side. The protective sheets 15, 16 on the both sides of the material remain until the third step S13, processing step of the bent polarized material 6a. In this second manufacturing method, the surface of polarized material 6a is protected from contact from outside and dusts because sheet shaped polarized material 6a has protective sheets 15, 16 until this third step S13.

Next, fourth step S14 of tinting will be described. When proceeding from the third step S13 to the forth step S14, the protective sheet 16 on the concave side of the protective sheets 15, 16 on the both sides is removed beforehand. In the fourth step S14 of tinting in dyeing liquid, only tinted layer 18 on the convex surface is disposed because the protective sheet 15 is remaining on the convex surface of the polarized material 6. This tinted layer 18 is disposed to have gradation pattern by immersing in dyeing liquid with up-and-down, similar to the first manufacturing method.

Next, the fifth step S15 of forming step will be described. When proceeding from the forth step S14 to the fifth step S15, the protective sheet 15 on the convex surface is removed beforehand and a polycarbonate molded part 7 is formed as described in the first manufacturing method. Then, in next the sixth step S16, an outermost hard coat layer 19 is disposed on the whole surface of the lens from an acrylic coat layer 5 on the convex surface to the polycarbonate molded part 7 on the concave surface including side surface. In this second manufacturing method, a primer layer 20 is disposed before disposing an outermost surface of hard coat layer 19, resulting in protective layer of two-layer and being a completed polycarbonate lens 21.

As stated above, the first and the second methods for manufacturing as methods for manufacturing of the polycarbonate lens for eyewear according to embodiment of the present invention are described, however, the methods should not be limited to these methods for manufacturing as long as it enables to manufacturing the polycarbonate lens for eyewear of the present invention.

Next, a plurality of samples of polycarbonate lenses that have conventional configuration and configuration according to the embodiment of the present invention is prepared, and evaluation result of the samples is described below.

Here, at first, semi-product of lenses of different condition is manufactured and needed process for the semi-product of lenses is performed, and ultimate samples of polycarbonate lens for eyewear are prepared. As to the condition of producing ultimate lens, 6 samples according to the embodiment are extracted based on whether acrylic coat layer or primer layer is provided, whether gradation dyeing is processed according to the above-mentioned embodiments. Evaluation on “hardness after hard coating”, “interference pattern” on lens surface, and “visual observation” is performed. These results are represented in Table 1.

| | | | | TABLE1 | | |
|---|---|---|---|---|---|---|
| | | | | evaluation | | |
| | condition | | | Hardness | interference | |
| | acrylic | gradation | | after hard | pattern on | visual |
| Samples | coat | tint | primer | coating | lens surface | observation |
| No1 | No | No | No | 2 | 2 | |
| No2 | No | No | Yes | 3 | 4 | |
| No3 | No | Yes | Yes | 3 | 4 | fine cracks on |
| | | | | | | surface |
| No4 | Yes | No | No | 4 | 4 | |
| No5 | Yes | No | Yes | 5 | 5 | |
| No6 | Yes | Yes | Yes | 5 | 5 | |

In Table 1, “surface hardness after hard coating” is evaluated by steel wool test by five grade evaluation and “interference pattern” on lens surface is visual-evaluated by five grade evaluation from “good: 5” to “bad: 1”. The following is examples of first to fourth semi-product lens before producing the six samples.

At first, first example include following steps,

a gray colored polarized sheet including PVA polarized film between stretch processed polycarbonate with 0.3 mm of thickness and removable protective sheets (Mitsubishi Gas, transmission of visible light: 35%) on the both sides of the polycarbonate is prepared. Next, the polarized sheet is processed into approximate lens shape (φ78 mm), and then the processed sheet is aspirated with heating at 130 degree in ten minutes on the concave dish 8R with an aspiration hole at the center to provide a polarized material with approximate 8R curvature. Then, the polarized material is removed the removable protective sheet of both sides and placed in metallic mold contacting convex surface of acrylic coat layer, and then injected polycarbonate to bind polycarbonate layer on the concave surface of polarized material in order to obtain a lens for eyewear with the exposed polycarbonate layer and gradation on the convex surface.

Also, the second example of semi-product of the lens is the following. A gray colored polarized sheet (transmission of visible light: 35%) including a PVA polarized film between stretch processed polycarbonate with thickness of 0.3 mm and removable protective layer (Mitsubishi Gas) on the both sides of thereof is prepared. Next, the polarized sheet is processed into approximate lens shape (φ78 mm), and then the processed sheet is aspirated with heating at 130 degree in 10 minutes on the concave dish 8R with an aspiration hole at the center of the dish to provide a polarized material with approximate 8R curvature. Then, the removable protective films of both sides are removed from the obtained polarized material, and then the polarized material is immersed little by little in BPI dyeing liquid(grey) heated at 80 degree with up-and-down and washed after 15 minute immersion. Here, the polarized material with gradation of vertical direction, which is dense in lower side and diluted in upper side during immersion, is obtained (transmission rate of upper side: 4%, geometric center: 9%, lower side: 33%). Moreover, the 8R shaped polarized material with vertical directed gradation is placed in a cavity of a metallic mold and injected polycarbonate to bind polycarbonate layer on the concave surface of polarized material in order to obtain a lens for eyewear with the exposed polycarbonate layer with gradation on the convex surface.

Also, the third example of semi-product of the lens is the following. A gray colored polarized sheet (transmission of visible light: 35%) including a PVA polarized film between stretch processed polycarbonate with thickness of 0.3 mm, a three dimensionally cross linked acrylic coat layer on the one side of polycarbonate, and removable protective layers (Mitsubishi Gas) on the both sides of thereof is prepared. Then, the polarized sheet is processed into approximate lens shape (78 mm) and placed on an 8R concave dish with aspiration hole at the center with acrylic coat layer low side and then aspirated with heating at 130 degree for 10 minutes to provide polarized material with 8R curvature. Then, the polarized material is removed the removable protective sheet of both sides and placed in metallic mold contacting convex surface of acrylic coat layer, and then injected polycarbonate to bind polycarbonate layer on the concave surface of polarized material in order to obtain a lens for eyewear with the exposed polycarbonate layer with gradation on the convex surface.

Also, the fourth example of semi-product of the lens is the following. A gray colored polarized sheet (transmission of visible light: 35%) including a PVA polarized film between stretch processed polycarbonate with thickness of 0.3 mm, a three dimensionally cross linked acrylic coat layer on the one side of polycarbonate, and removable protective layers (Mitsubishi Gas) on the both sides of thereof is prepared. Then, the polarized sheet is processed into approximate lens shape (78 mm) and placed on an 8R concave dish with aspiration hole at the center with acrylic coat layer low side and then aspirated with heating at 130 degree for 10 minutes to provide polarized material with 8R curvature. Then, the removable protective films of both sides are removed from the obtained polarized material, and then the polarized material is immersed little by little in BPI dyeing liquid(grey) heated at 80 degree with up-and-down and washed after 15 minutes immersion. Here, the polarized material with gradation of vertical direction, which is dense in lower side and diluted in upper side during immersion, is obtained (transmission rate of upper side: 6%, geometric center: 12%, lower side: 33%). Then, the polarized material is placed in metallic mold contacting convex surface of acrylic coat layer, and then injected polycarbonate to bind polycarbonate layer on the concave surface of polarized material in order to obtain a lens for eyewear with the exposed polycarbonate layer with gradation on the convex surface.

The fourth example semi-product of lens, in comparison with the second example of semi-product of lens, shows low concentration of gradation on the surface of polarized material. However, it does not show white turbidity and grazing when magnified, which are shown in second example of semi-product of lens.

Here, the relation between the first example of semi-product to the fourth example of semi-product and six examples will be described. At first, the sample 1 is semi-product produced in first example further including hard coat layer on the surface of thereof. Second, the sample 2 is semi-product produced in second example further including a primer layer and a hard coat layer on it. Third, the sample 3 is semi-product produced in example 2 further including a primer layer and a hard coat layer on it. Fourth, the sample 4 is semi-product produced in third example further including a hard coat layer on it. Fifth, the sample 5 is semi-product produced in example 3 further including a primer layer and a hard coat layer on it. Sixth, the sample 6 is semi-product produced in example 4 further including a primer layer and a hard coat layer on it.

According to table 1 that shows evaluation of 6 samples above, samples 4 to 6 of polycarbonate lenses for eyewear, which include an acrylic coat layer on the surface of the polycarbonate protective layer on one side surface thereof, and further include a hard coat layer on the surface of the acrylic coat layer, as described in the embodiment 1 and the following embodiments, have better “surface hardness” comparison with samples 1 to 3, which do not include. Moreover, samples 5 and 6 with a hard coat layer of two-layer including a primer layer have better “surface hardness”. In addition, as to “interference pattern”, the lens with both of an acrylic coat layer and a primer layer has better result, regardless whether the gradation dyeing is performed.

What is claimed is:

1. A polarized polycarbonate lens for eyewear, comprising:
a polarized layer having polarizing function;
a polycarbonate protective layer on both sides of the polarized layer;
an acrylic coat layer on one side of the polycarbonate protective layers;
a polarizing material formed into lens shape having the acrylic coat layer on the convex surface thereof;
a polycarbonate molded part formed integrally on concave surface of the polarizing material; and,
a hard coat layer over the whole surface of the lens including the acrylic coat layer on the convex surface.

2. The polycarbonate lens for eyewear according to claim 1, wherein the hard coat layer on the acrylic coat layer is consisting of two-layer including primer layer and hard coat layer.

3. The polycarbonate lens for eyewear according to claim 1, wherein the polarized material comprises a tinted layer on one or both sides of the acrylic coat layer on the convex surface and polycarbonate protective layer on the concave surface.

4. A method for manufacturing a polycarbonate lens for eyewear according to claim 1, comprising the step of:
(a) preparing a polarized material sheet comprising: a polarized film having polarizing function; a polycarbonate protective layer on the both sides of the polarizing film; and an acrylic coat layer on one side of the polycarbonate protective layers;
(b) processing the polarized material into lens shape and bending to polarizing material which provides specific curvature, so that the surface coated by the acrylic coat layer becomes convex surface;
(c) forming integrally a molded part intended to be lens entity by means of injection molding polycarbonate on the concave surface of the polarized material; and
(d) disposing a hard coat layer over the whole surface of the lens including the acrylic coat layer on the convex surface.

5. A method for manufacturing a polycarbonate lens for eyewear according to claim 3, comprising the step of:
(a) preparing a polarized material sheet comprising: a polarized film having polarizing function; a polycarbonate protective layer on the both sides of the polarizing film; and an acrylic coat layer on one side of the polycarbonate protective layers;
(b) processing the polarized material into lens shape and bending to polarizing material which provides specific curvature, so that the surface coated by the acrylic coat layer becomes convex surface;
(c) tinting the surface of the polarized material by means of immersing in dyeing liquid;
(d) forming integrally a molded part intended to be lens entity by means of injection molding polycarbonate on the concave surface of the polarized material; and
(e) disposing a hard coat layer over the whole surface of the lens including the acrylic coat layer on the convex surface.

6. The method for manufacturing of the polycarbonate lens for eyewear according to claim 5, wherein the step (c) further comprises immersing polarizing material into dyeing liquid up-and-down to obtain gradation pattern.

7. The method for manufacturing of the polycarbonate lens for eyewear according to claim 5, wherein the step (e) is disposing two-layers including a primer layer and a hard coat layer.

8. The method for manufacturing of the polycarbonate lens for eyewear according to claim 5, wherein the polarized material sheet includes removable protective sheet on both sides of the polarized material sheet, the method further comprises removing of at least protective sheet on concave surface between processing the polarized material and tinting, and the step (c) is tinting concave surface if the protective sheet on concave surface is removed independently and tinting both of surfaces if both of the protective sheets are removed.

9. The method for manufacturing of the polycarbonate lens for eyewear according to claim 8, wherein the step (e) is disposing two-layer including a primer layer and a hard coat layer.

10. The method for manufacturing the polycarbonate lens for eyewear according to claim 8, wherein the removing comprises removing the protective sheet on convex surface after the tinting, and then tinting on concave surface not on convex surface.
